(19) United States
(12) Patent Application Publication
(10) Pub. No.: US 2026/0236601 A1
(43) Pub. Date: Aug. 13, 2026

(54) PERMISSION INFORMATION DISPLAY METHOD, APPARATUS, ELECTRONIC DEVICE, STORAGE MEDIUM, AND PROGRAM PRODUCT

(71) Applicant: Beijing Zitiao Network Technology Co., Ltd., Beijing (CN)

(72) Inventors: Chao FAN, Beijing (CN); Xuebin YANG, Beijing (CN); Hao LI, Beijing (CN); Jie CAO, Beijing (CN); Jiangxing YANG, Beijing (CN)

(21) Appl. No.: 19/540,474

(22) Filed: Feb. 13, 2026

(30) Foreign Application Priority Data
Feb. 28, 2025 (CN) 202510238293.5

(51) Int. Cl. G06F 21/62; G06F 3/0482; G06F 3/04842

(52) U.S. Cl. CPC G06F 21/6218; G06F 3/0482; G06F 3/04842

(57) ABSTRACT

Embodiments of the present disclosure provide a permission information display method and apparatus, an electronic device, a storage medium, and a program product. The method includes: displaying first interactive content in a first area of a first interactive page, where the first interactive content is generated based on at least one item of reference content, and reference content information about at least some of the reference content is displayed in association with the first interactive content; and displaying permission source information about an access permission of a target account for the reference content, in response to a permission source display operation for the reference content. These embodiments, using the above method, are able to display the permission source information about the reference content, improve data security in a process in which a user obtains content, and reduce a risk of data leakage.

### CROSS-REFERENCE TO RELATED APPLICATION(S)

This application claims priority to Chinese Application No. 202510238293.5 filed in February 28, 2025, the disclosure of which is incorporated herein by reference in its entirety.

### FIELD

Embodiments of the present disclosure relate to the field of computer technologies, and in particular, to a permission information display method and apparatus, an electronic device, a storage medium, and a program product.

### BACKGROUND

In some applications, when interactive content generated based on reference content is displayed, a user may be supported to obtain and view related information about the reference content.

### SUMMARY

Embodiments of the present disclosure provide a permission information display method and apparatus, an electronic device, a storage medium, and a program product.

According to a first aspect, an embodiment of the present disclosure provides a permission information display method, including:

displaying first interactive content in a first area of a first interactive page, the first interactive content being generated based on at least one item of reference content, and reference content information about at least some of the reference content being displayed in association with the first interactive content; and

displaying permission source information about an access permission of a target account for the reference content, in response to a permission source display operation for the reference content.

According to a second aspect, an embodiment of the present disclosure further provides a permission information display apparatus, including:

an interactive content display module, configured to display first interactive content in a first area of a first interactive page, the first interactive content being generated based on at least one item of reference content, and reference content information about at least some of the reference content being displayed in association with the first interactive content; and

a source information display module, configured to display permission source information about an access permission of a target account for the reference content, in response to a permission source display operation for the reference content.

According to a third aspect, an embodiment of the present disclosure further provides an electronic device, including:

one or more processors; and

a memory, configured to store one or more programs,

where the one or more programs, when executed by the one or more processors, cause the one or more processors to implement the permission information display method according to the embodiment of the present disclosure.

According to a fourth aspect, an embodiment of the present disclosure further provides a computer-readable storage medium having a computer program stored thereon, where the program, when executed, implements the permission information display method according to the embodiment of the present disclosure.

According to a fifth aspect, an embodiment of the present disclosure further provides a computer program product which, when executed by a computer, causes the computer to implement the permission information display method according to the embodiment of the present disclosure.

### BRIEF DESCRIPTION OF THE DRAWINGS

The foregoing and other features, advantages, and aspects of the embodiments of the present disclosure become more apparent with reference to the following specific implementations and in conjunction with the drawings. Throughout the drawings, the same or similar reference numerals denote the same or similar elements. It should be understood that the drawings are schematic and that parts and elements are not necessarily drawn to scale.

FIG. 1 is a schematic flowchart of a permission information display method according to an embodiment of the present disclosure;

FIG. 2 is a schematic diagram of a display process of first interactive content according to an embodiment of the present disclosure;

FIG. 3 is a schematic diagram of displaying permission source information according to an embodiment of the present disclosure;

FIG. 4 is a schematic diagram of displaying function explanation information according to an embodiment of the present disclosure;

FIG. 5 is a schematic flowchart of another permission information display method according to an embodiment of the present disclosure;

FIG. 6 is a block diagram of a permission information display apparatus according to an embodiment of the present disclosure; and

FIG. 7 is a schematic diagram of a structure of an electronic device according to an embodiment of the present disclosure.

### DETAILED DESCRIPTION OF EMBODIMENTS

Embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein. Instead, these embodiments are provided for more thorough and complete understanding of the present disclosure. It should be understood that the drawings and embodiments of the present disclosure are only used for exemplary purposes, and are not used to limit the protection scope of the present disclosure.

It should be understood that steps described in method implementations of the present disclosure may be performed in different orders, and/or performed in parallel. In addition, the method implementations may include additional steps and/or omit performing the illustrated steps. The scope of the present disclosure is not limited in this respect.

The term "include/comprise" and its variants used herein are open-ended inclusions, that is, "include/comprise but not limited to". The term "based on" is "at least partially based on". The term "an embodiment" means "at least one embodiment"; the term "another embodiment" means "at least one another embodiment"; and the term "some embodiments" means "at least some embodiments". Related definitions of other terms will be given in the following description.

It should be noted that concepts such as "first" and "second" mentioned in the present disclosure are only used to distinguish between different apparatuses, modules, or units, and are not used to limit an order or interdependence of functions performed by these apparatuses, modules, or units.

It should be noted that modifications of "one" and "multiple" mentioned in the present disclosure are schematic rather than restrictive, and those skilled in the art should understand that unless otherwise clearly indicated in the context, they should be understood as "one or more".

The names of messages or information exchanged between multiple apparatuses in the implementations of the present disclosure are only used for illustrative purposes, and are not used to limit the scope of these messages or information.

It may be understood that data involved in the technical solution (including but not limited to the data itself, acquisition or use of the data) shall comply with requirements of corresponding laws, regulations, and related provisions.

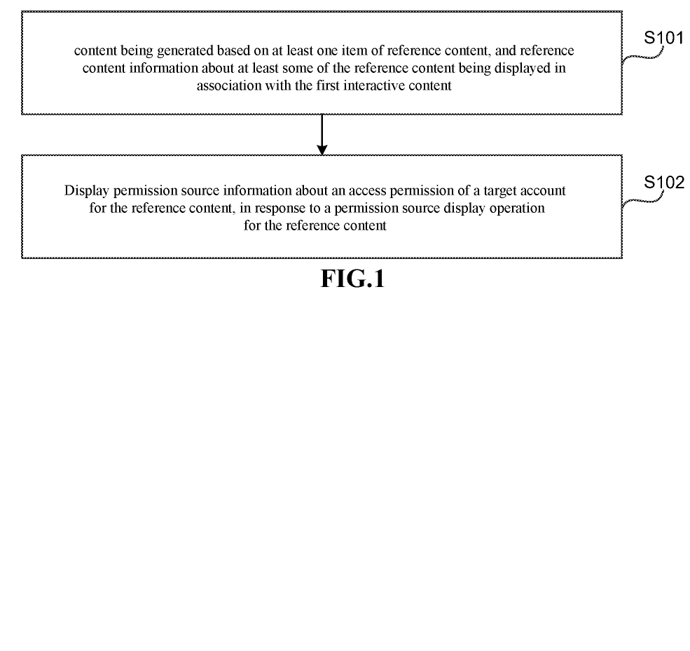

As discussed above, in some applications, when interactive content generated based on reference content is displayed, a user may be supported to obtain and view related information about the reference content. However, data security in a content obtaining process is relatively low. FIG. 1 is a schematic flowchart of a permission information display method according to an embodiment of the present disclosure. The method may be performed by a permission information display apparatus. The apparatus may be implemented in software and/or hardware, may be configured in an electronic device, and typically may be configured in a computer, a mobile phone, or a tablet computer. The permission information display method provided in the embodiment of the present disclosure is applicable to a scenario of displaying permission source information about reference content on which interactive content is based when the interactive content is generated. As shown in FIG. 1, the permission information display method provided in this embodiment may include the following steps.

S101: first interactive content is displayed in a first area of a first interactive page, where the first interactive content is generated based on at least one item of reference content, and reference content information about at least some of the reference content is displayed in association with the first interactive content.

The first interactive content may be interactive content generated based on one or more items of reference content. A generation timing of the first interactive content is not limited. In some examples, the first interactive content may include reply content for another item of received interactive content (such as third interactive content), for example, the first interactive content may be used to reply to a question included in the another item of interactive content. Types of the first interactive content and the third interactive content are not limited. Exemplarily, the first interactive content and the third interactive content may both be conversation messages; and/or the third interactive content may be search content, and the first interactive content may be a search result corresponding to the search content.

The first interactive page may be understood as a page in which the first interactive content is displayed, for example, a conversation page, a conference page, or a search result page. The first area may be an area in the first interactive page that is used to display the interactive content. The following uses an example in which the first interactive page is the conversation page, the first area is a message display area in the first interactive page, and the first interactive content is a conversation message.

The reference content of the first interactive content may be understood as a data source which is referred to when the first interactive content is generated. A type of the reference content is not limited. For example, the reference content may be a document, other interactive content other than the first interactive content, a question-and-answer entry in a preset question-and-answer database, an entry, or conference content. The reference content is content that a target account has an access permission for. For example, when the first interactive content is generated, one or more items of content that the target account has an access permission for may be acquired as the reference content. The reference content information about the reference content may be understood as information, displayed in association with the first interactive content, about the reference content of the first interactive content, for example, a name of the reference content. The target account may be understood as an account that is currently logged in to an application that performs the permission information display method provided in the embodiment of the present disclosure.

Specifically, the first interactive content may be displayed in the first area of the first interactive page. For example, the first interactive page is displayed, and the generated first interactive content is displayed in the first area of the first interactive page, or the first interactive content is generated in the first area of the first interactive page based on one or more items of reference content. In addition, the reference content information about at least some of the reference content, on which the first interactive content is based when the first interactive content is generated, is displayed at an associated position of the first interactive content, for the user to view. The associated position of the first interactive content may be understood as a position associated with the first interactive content. A specific position of the associated position is not limited. For example, the associated position may be located above, below, on the left side, or on the right side of the first interactive content, or at least partially overlap with a display position of the first interactive content.

In this embodiment, the generation timing of the first interactive content is not limited. Exemplarily, the first interactive content may be automatically generated and displayed when a preset generation condition is satisfied. For example, when the reference content associated with the question that the first interactive content is used to reply to is updated, which causes the reply content of the question to change, the first interactive content is re-generated based on the updated reference content and displayed in the first area of the first interactive page, to prompt the user that the reply content of the question is updated, so that the user may view the updated content in a timely manner.

In some implementations, the first interactive content corresponding to third interactive content may be generated in response to the third interactive content sent by the target account, and the third interactive content sent by the target account is replied to through the first interactive content, which simplifies operations that the user needs to perform to obtain and view the reply content.

Optionally, the first interactive content includes reply content to third interactive content, and an action of displaying the first interactive content in the first area of the first interactive page includes: generating the reply content corresponding to a target question in the first area in response to receiving the third interactive content in the first area of the first interactive page, where the third interactive content includes the target question.

The target question may be understood as a question included in the third interactive content. A type of the target question is not limited. For example, the target question may include a business question, for example, a question that the user asks for a business associated with the user; or may include a non-business question, for example, a question that is asked by the user and that is not related to the business associated with the user. The reply content of the target question may be content used to reply to the target question. The third interactive content may be interactive content corresponding to the first interactive content, or in other words, interactive content that the first interactive content is used to reply to. Taking a conversation scenario as an example, exemplarily, the third interactive content may be a conversation message that is sent by the target account to a virtual object and that includes the target question; and the first interactive content may be a conversation message that is generated by the virtual object based on at least one item of reference content that the target account has an access permission for and that is used to reply to the target question included in the third interactive content. The virtual object may be, for example, an intelligent assistant, a chat robot, or a virtual contact.

Specifically, after the third interactive content is received in the first area of the first interactive page, the first interactive content corresponding to the target question included in the third interactive content may be generated in response to receiving the third interactive content, and the target question included in the third interactive content is replied to through the first interactive content.

In some examples, after a sending operation for the third interactive content is received, the third interactive content may be sent in response to the sending operation, and the sent third interactive content is displayed in the first area of the first interactive page. For example, the user may input the third interactive content in an interactive content input area of the first interactive page and trigger a sending control in the first interactive page. When detecting that the user triggers the sending control in the first interactive page, the current application may send the third interactive content input in the interactive content input area; or the user may input the third interactive content in a page different from the first interactive page and trigger a sending control in this page. When detecting that the user triggers the sending control in this page, the current application may display the first interactive page, and display the third interactive content in the first area of the first interactive page.

After the third interactive content is sent, the first interactive content used to reply to the third interactive content may be generated in the first area of the first interactive page in response to the sending of the third interactive content. For example, at least one item of reference content that is associated with the target question included in the third interactive content and that the target account has an access permission for is acquired, and the reply content of the target question included in the third interactive content is generated based on the at least one item of reference content, to obtain the first interactive content. The first interactive content is displayed in the first area of the first interactive page.

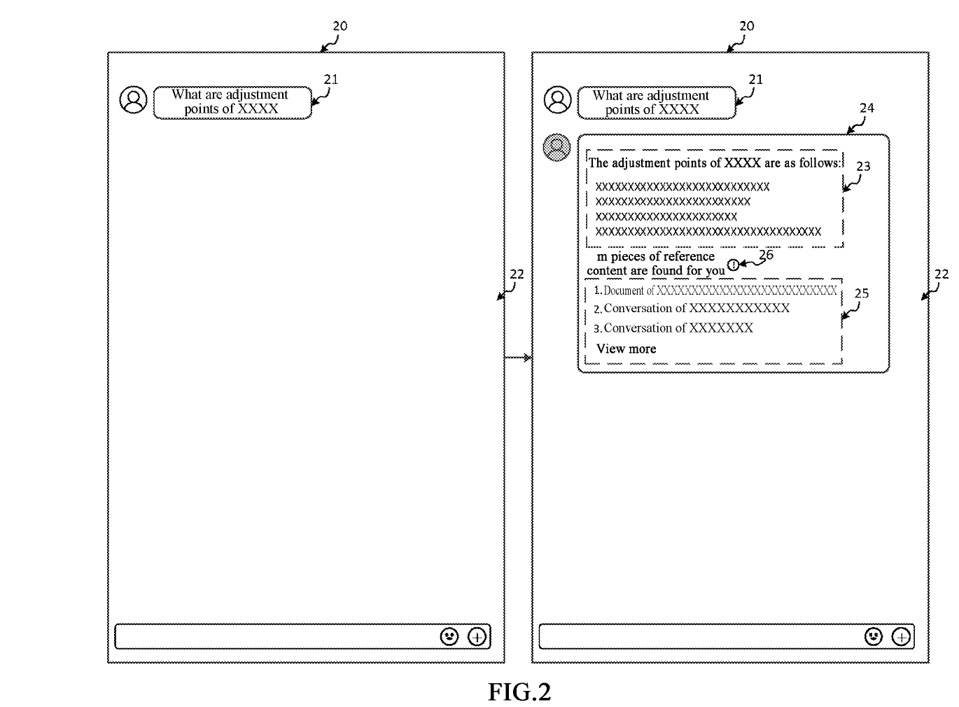

Taking a conversation scenario as an example, in some optional implementations, the first interactive page 20 (such as a conversation page) between the user and the virtual object may be displayed, the third interactive content 21 (such as a conversation message) is sent in response to a sending operation of the user in the first interactive page 20, and the third interactive content 21 sent by the user is displayed in the first area 22 (such as a conversation message display area) of the first interactive page 20, as shown in the first figure in FIG. 2. In addition, in response to the sending of the third interactive content 21, at least one item of reference content that is associated with the third interactive content 21 and that the user has an access permission for is acquired, reply content 23 of the third interactive content is generated based on the reference content, the first interactive content 24 (such as a reply message) including the reply content 23 is displayed in the first area 22 of the first interactive page 20, and the reference content information 25 of at least some of the reference content when the reply content 23 is generated is displayed in association with the first interactive content 24, as shown in the second figure in FIG. 2, so that the user may view the reply content 23 of the third interactive content 21 sent by the user and the reference content information 25 of at least some of the reference content on which the reply content 23 is based.

With continued reference to FIG. 2, in some examples, the reference content information 25 may be displayed in the first interactive content 24 as part of message content of the first interactive content 24. In this case, the first interactive content 24 may include the reply content 23 of the third interactive content 21 and the reference content information 25 of at least some of the reference content on which the reply content 23 is based.

S102: permission source information about an access permission of a target account for the reference content is displayed, in response to a permission source display operation for the reference content.

The permission source display operation may be a trigger operation used to instruct to display the reference content information about one or more items of the reference content of the first interactive content. An execution manner of the permission source display operation is not limited. Exemplarily, the permission source display operation may include an operation of triggering (for example, clicking) a permission source display control displayed in the first interactive page, or an operation of performing a preset swipe gesture in the first interactive page. Optionally, the permission source display control is further displayed in association with the first interactive content, and the permission source display control is configured to trigger to perform the permission source display operation. A display position of the permission source display control is associated with the first interactive content. For example, the permission source display control may be displayed in the first interactive content or at a position near the first interactive content.

The access permission for the reference content may be understood as a permission to access the reference content, for example, a permission to view the reference content. The permission source information about an item of reference content may be information used to indicate a permission source of the access permission of the target account for the reference content, for example, information used to indicate a permission acquisition manner in which the target account acquires the access permission for the reference content. In the case where the reference content is a document, the permission source acquisition manner may include, for example, acquiring the access permission for the document through an account, a group, a department, a user group, a conference, a schedule, or a knowledge database; acquiring the access permission for the document based on a change in document permission of the document itself, for example, acquiring the access permission for the document because the document enables the permission that the document may be accessed or searched by a person within an organization, an associated organization, and/or the Internet who obtains a link; and/or acquiring the access permission for the document through an access permission application for the document. In the case where the reference content is a conversation message in a conversation (including a single chat and/or a group chat), the permission source acquisition manner may be that the target account is a conversation member in the conversation, for example, the conversation member in the conversation may acquire the access permission for the conversation message in the conversation. In the case where the reference content is a question-and-answer entry in the preset question-and-answer database, the permission acquisition manner may be that the access permission for the question-and-answer entry is acquired through the preset question-and-answer database. In the case where the reference content is an entry, the permission acquisition manner may be that the access permission for the entry is acquired through the entry. In the case where the reference content is conference content, the permission acquisition manner may be that the target account is a participant in the conference, for example, the participant in the conference may acquire the access permission for the conference content.

Information content of the permission source information is not limited. Exemplarily, the permission source information about an item of reference content may include description information about the permission source of the access permission of the target account for the reference content, and may further include identification information about the reference content, for example, a name of the reference content.

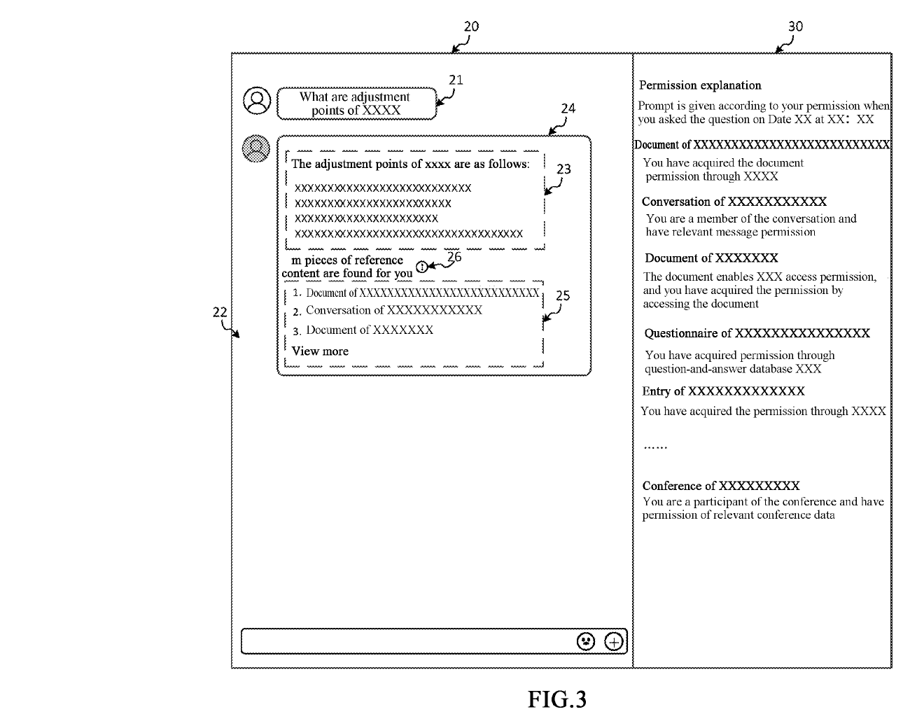

Specifically, when the permission source display operation for the reference content of the first interactive content 24 is received, for example, when it is detected that the user triggers the permission source display control 26 (as shown in FIG. 2) displayed in association with the first interactive content 24, the permission source information about the access permission of the target account for one or more items of reference content may be displayed, as shown in FIG. 3.

In this embodiment, the permission source information about the access permission of the target account for one or more items of reference content may be displayed in response to the permission source display operation.

Taking the permission source display operation acting on the permission source display control and the first interactive content including a plurality of items of reference content as an example. Exemplarily, as shown in FIG. 2, only one permission source display control may be displayed in association with the first interactive content, and when it is detected that the user triggers the permission source display control, the permission source information about the plurality of items of reference content of the first interactive content may be displayed, as shown in FIG. 3; or a plurality of permission source display controls may be displayed in association with the first interactive content, for example, a permission source display control corresponding to each item of reference content may be displayed in association with the first interactive content. When it is detected that the user triggers the permission source display control corresponding to an item of reference content, the permission source information about the reference content may be displayed.

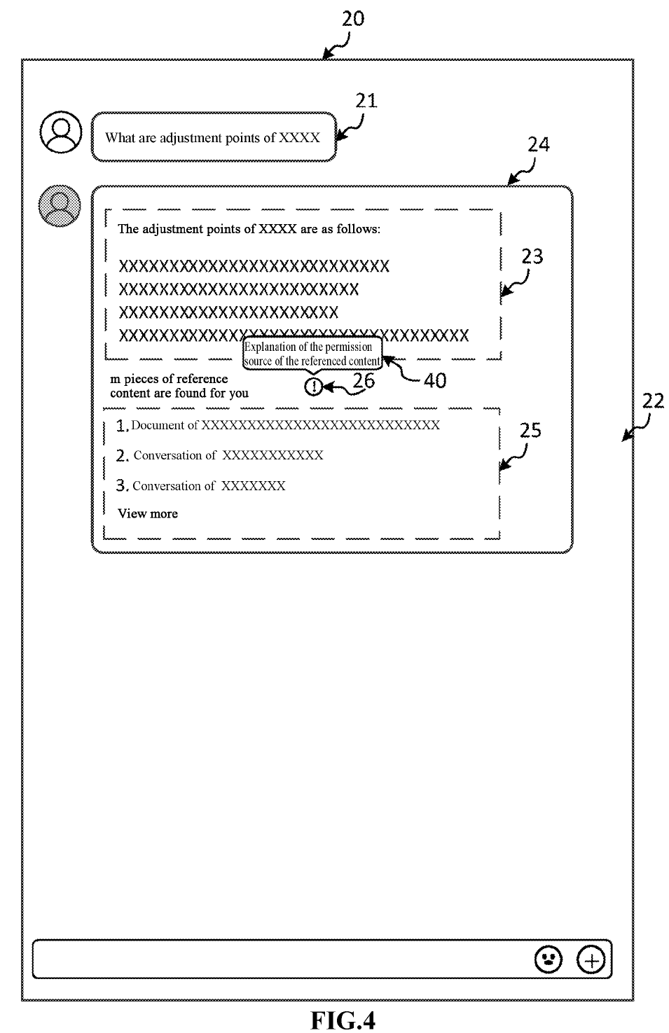

In addition, as shown in FIG. 4, when a preset display condition of function explanation information 40 is satisfied, when it is detected that the user moves an input indicator (such as a cursor) to a display position of the permission source display control 26, when it is detected that the user places the input indicator over the display position of the permission source display control 26, or when a preset trigger operation (such as a long press operation) of the user for the permission source display control is received, the function explanation information 40 of the permission source display control 26 may be displayed, and the user is prompted through the function explanation information 40 that the user may view the permission source information about the reference content by triggering the permission source display control 26.

When the permission source information about the reference content of the first interactive message is displayed, an acquisition time of the permission source information may be further displayed. For example, a sending time of the third interactive content and/or a generation time of the first interactive content may be used as the acquisition time of the permission source information, to prompt the user that the displayed permission source information is the permission source information for the reference content at the corresponding acquisition time, further enrich the displayed content, and avoid the user having doubts about the displayed permission source information due to different acquisition times.

In this embodiment, the permission source information may be displayed in the first interactive page, or may be displayed in another page (such as the permission source information page) different from the first interactive page, to further enrich the display manner of the permission source information.

Optionally, an action of displaying the permission source information about the access permission of the target account for the reference content includes: displaying the permission source information about the access permission of the target account for the reference content in a third area of the first interactive page; or displaying a permission source information page corresponding to the first interactive content, and displaying the permission source information about the access permission of the target account for the reference content on the permission source information page.

The third area may be understood as an area in the first interactive page that is used to display the permission source information, and the third area and the first area may be different areas in the first interactive page. The permission source information page may be a page used to display the permission source information, and the permission source information page and the first interactive page may be different pages.

Exemplarily, in response to the permission source display operation for the reference content, the third area may be created in the first interactive page 20, and the permission source information about the access permission of the target account for the reference content may be displayed in the third area; or the permission source information page 30 may be displayed, and the permission source information about the access permission of the target account for the reference content may be displayed on the permission source information page 30, as shown in FIG. 3.

In some implementations, an action of displaying the permission source information page corresponding to the first interactive content includes: displaying continuously the first interactive page, and displaying additionally the permission source information page corresponding to the first interactive content; or switching a currently displayed page from the first interactive page to the permission source information page corresponding to the first interactive content.

In the preceding implementations, when the permission source information page 30 is displayed, the first interactive page 20 may be kept displayed or the first interactive page 20 may be canceled to be displayed, to further enrich the display manner of the permission source information. For example, the first interactive page 20 may be kept displayed, and the permission source information page 30 is additionally displayed, as shown in FIG. 3 (in the figure, the permission source information page 30 is displayed on the right side of the first interactive page 20 as an example); or a currently displayed page may be switched from the first interactive page 20 to the permission source information page 30. When the first interactive page 20 is kept displayed, a relative position between the permission source information page 30 and the first interactive page 20 is not limited. For example, the permission source information page may be displayed in a preset position; or the permission source information page may be displayed in a position associated with the first interactive page 20, for example, on one side of the first interactive page 20.

In the permission information display method provided in this embodiment, the first interactive content is displayed in the first area of the first interactive page, where the first interactive content is generated based on at least one item of reference content, and reference content information about at least some of the reference content is displayed in association with the first interactive content; and the permission source information about the access permission of the target account for the reference content is displayed in response to the permission source display operation for the reference content of the first interactive content. In the preceding technical manner in this embodiment, when the interactive content generated based on the reference content is displayed, the user is supported to view the permission source information about the access permission of the user for the reference content, the permission source information about the reference content may be displayed, data security in a process in which the user obtains content is improved, and a risk of data leakage is reduced.

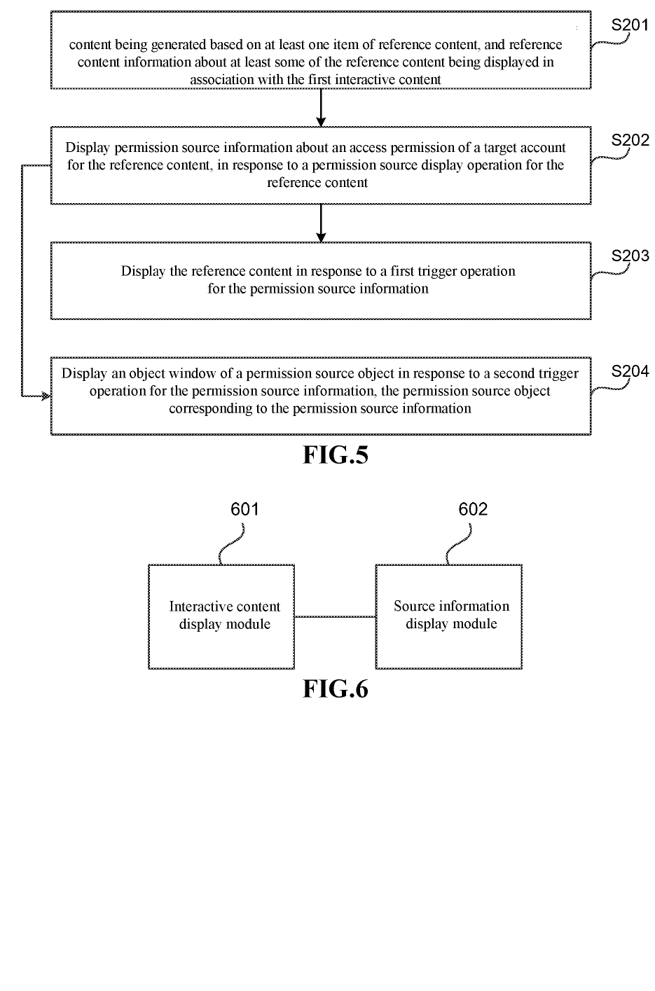

FIG. 5 is a schematic flowchart of another permission information display method according to an embodiment of the present disclosure. The solution in this embodiment may be combined with one or more optional solutions in the preceding embodiment. Optionally, after displaying the permission source information about the access permission of the target account for the reference content, the method further includes: displaying the reference content in response to a first trigger operation for the permission source information; and/or displaying an object window of a permission source object in response to a second trigger operation for the permission source information, where the permission source object corresponds to the permission source information.

Correspondingly, as shown in FIG. 5, the permission information display method provided in this embodiment may include the following steps.

S201: first interactive content in a first area of a first interactive page is displayed, where the first interactive content is generated based on at least one item of reference content, and reference content information about at least some of the reference content is displayed in association with the first interactive content.

S202: permission source information about an access permission of a target account for the reference content is displayed, in response to a permission source display operation for the reference content, and S203 and/or S204 is performed.

S203: the reference content is displayed in response to a first trigger operation for the permission source information.

The first trigger operation may be a trigger operation used to instruct to display the reference content corresponding to the permission source information. An execution manner of the first trigger operation is not limited. For example, the first trigger operation may include an operation of triggering identification information, included in the permission source information, of the corresponding reference content, or an operation of triggering a reference content display control displayed in association with the permission source information. The identification information about the reference content may include, for example, but is not limited to, a name of the reference content. When types of the reference content are different, manners of determining the name may be different. For example, the name of the reference content of a document type may be a title of the document; the name of the reference content of an interactive message type may be a name of a conversation corresponding to the interactive message or at least part of message content of the interactive message; the name of the reference content of a question-and-answer entry type may be at least part of question content of a question in the question-and-answer entry; the name of the reference content of an entry type may be an entry name; and the name of the reference content of a conference content type may be a conference name of a conference corresponding to the conference content.

Specifically, when the first trigger operation for the permission source information is received, for example, when it is detected that the user triggers the identification information, included in the permission source information about an item of reference content, of the reference content, part or all of content of the reference content may be displayed. For example, a reference content window may be displayed in the first interactive page or the permission source information page, and part or all of the content of the reference content is displayed in the reference content window; or a display page of the reference content is displayed, and part or all of the content of the reference content is displayed on the display page.

In some implementations, an action of displaying the reference content includes at least one of the following: in response to the reference content being a document, displaying document content of the document; in response to the reference content being second interactive content, displaying the second interactive content in a second area of a second interactive page; in response to the reference content being a question-and-answer entry in a preset question-and-answer database, displaying entry content of the question-and-answer entry; in response to the reference content being an entry, displaying entry content of the entry; or in response to the reference content being conference content, displaying conference data of the conference content.

The second interactive content may be understood as interactive content referred to when the first interactive content is generated, and the second interactive content and the first interactive content may be different interactive content. Taking a conversation scenario as an example, the second interactive content and the first interactive content may be different conversation messages in a same conversation or in different conversations. The following uses an example in which the second interactive content and the first interactive content are conversation messages in different conversations. The second interactive page may be an interactive page in which the second interactive content is located. Taking the conversation scenario as an example, the second interactive page may be a conversation page of a conversation corresponding to the second interactive content. The second interactive area may be an area in the second interactive page that is used to display the interactive content.

The preset question-and-answer database may be a preset question-and-answer database, for example, a preset frequently asked questions (FAQ) database. The preset question-and-answer database may include one or more preset question-and-answer entries, and each question-and-answer entry may include a preset question and answer content corresponding to the question. Questions included in different question-and-answer entries may be different. An entry is a basic unit in a knowledge system, and refers to an entry that systematically explains a specific thing, concept, or term, which is commonly found in a dictionary, an encyclopedia, a database, or the like.

Exemplarily, when the first trigger operation for the permission source information about the reference content of the document type is received, the document content of the document may be displayed, for example, part or all of the document content of the document is displayed on the first interactive page, the permission source information page, or the display page of the document.

When the first trigger operation for the permission source information about the reference content of the interactive content type is received, the reference content of the interactive message type, that is, the second interactive content, may be displayed in the second area of the second interactive page. Taking the conversation scenario as an example, the conversation page of the conversation corresponding to the second interactive content may be displayed, and the second interactive content is displayed on the conversation page. For example, the second interactive content on the conversation page may be located on the conversation page, so that the user may view the second interactive content.

When the first trigger operation for the permission source information about the reference content of the question-and-answer entry type is received, the entry content of the question-and-answer entry may be displayed, for example, a display interface (such as a display window or a display page) of the question-and-answer entry is displayed, and the entry content of the question-and-answer entry is displayed on the display interface.

When the first trigger operation for the permission source information about the reference content of the entry type is received, the entry content of the entry may be displayed, for example, a display interface of the entry is displayed, and the entry content of the entry is displayed on the display interface.

When the first trigger operation for the permission source information about the reference content of the conference content type is received, the conference data of the conversation content may be displayed, for example, a display interface of the conference data of the conference content is displayed, and the conference data of the conference content is displayed on the display interface.

In the preceding implementations, in the case where the reference content is the document, when the document content of the document is displayed, a reference paragraph, referred to when the first interactive content is generated, in the document may be located, for example, paragraph content of the reference paragraph is displayed, to simplify an operation that the user needs to perform to view the content, referred to by the first interactive content, in the document; or a preset paragraph of the document may be located, for example, paragraph content of the preset paragraph in the document is displayed, so that the user may view the document content of the document by using the preset paragraph as a viewing starting point. In this case, optionally, displaying the document content of the document includes: displaying paragraph content of a reference paragraph, corresponding to the first interactive information, in the document; or displaying paragraph content of a preset paragraph in the document. The reference paragraph may be understood as a paragraph, referred to when the first interactive content is generated, in the document, for example, a paragraph, associated with the first interactive content, in the document. The preset paragraph may be understood as a preset paragraph, for example, a first paragraph or a key paragraph of the document, which is not limited in this embodiment.

In the preceding implementations, a display manner of the conference data of the conference content is not limited. For example, conference video data of the conference content may be played, conference audio data of the conference content may be played, conference text data obtained by performing speech recognition on the conference audio data of the conference content may be displayed, and/or conference summary data of the conference content may be displayed, to further enrich the display manner of the conference data. In this case, optionally, the conference data includes at least one of conference video data, conference audio data, conference text data, and conference summary data, and the conference text data is obtained by performing speech recognition on the conference audio data. The conference video data may be understood as video data of the conference content. It may be understood that the video data includes audio data, that is, when the video data of the conference content is played, the audio data included in the video data may be played synchronously. The conference audio data may be understood as audio data of the conference content. The conference text data may be text data obtained by performing speech recognition on the conference audio data. The conference summary data may be understood as summary data of the conference content that is obtained by performing content summarization on the conference content, for example, a conference summary of the conference content.

S204: an object window of a permission source object is displayed in response to a second trigger operation for the permission source information, where the permission source object corresponds to the permission source information.

The second trigger operation may be a trigger operation used to instruct to display the object window of the permission source object corresponding to the permission source information. An execution manner of the second trigger operation is not limited. For example, the second trigger operation may include a trigger operation of triggering object identification information, included in the permission acquisition manner of the permission source information, of the permission source object.

The permission source object of an item of reference content may be understood as an object that enables the target account to acquire the access permission for the reference content, in other words, an object on which the target account depends to acquire the access permission for the reference content. A type of the permission source object is not limited. For example, the permission source object may be an account, a conversation, a department, a user group, a conference, a schedule, a knowledge base, and/or a question-and-answer database.

The object window of the permission source object may be a window associated with the permission source object, for example, an object information window, an interactive window, a document collection window, or a media content collection window of the permission source object. The object information window may be used to display object information about the permission source object, for example, object profile information about the permission source object. The interactive window may be a window for interacting with the permission source object, for example, a conversation window. The document collection window may be used to display a document collection of the permission source object, and document information about one or more documents associated with the permission source object may be displayed in the document collection. The media content collection window may be used to display a media content collection of the permission source object, and media content information about one or more items of media content associated with the permission source object may be displayed in the media content collection.

Specifically, when the second trigger operation for the permission source information is received, for example, when it is detected that the user triggers the object identification information, included in the permission source information about an item of reference content, of the permission source object, the object window of the permission source object may be displayed, so that the user may view object information about the permission source object and/or interact with the permission source object.

In some implementations, when the second trigger operation for the permission source information is received, the object window of the permission source object corresponding to the permission source information may be displayed, for example, the object information window of the permission source object is displayed, for the user to view the object information about the permission source object in the object information window; or the interactive window of the permission source object, for example, a conversation window of the permission source object, is displayed for the user to interact with the permission source object. In this case, optionally, an action of displaying the object window of the permission source object includes: displaying an object information window of the permission source object, and displaying object information about the permission source object in the object information window; or displaying an interactive window of the permission source object, where the interactive window is used to perform an interaction associated with the permission source object.

In the preceding implementations, the object window displayed in response to the second trigger operation may be preset; or the object window may be determined based on the second trigger operation. For example, when the received second trigger operations are different, different object windows of the permission source object may be displayed, and so on, which is not limited in this embodiment.

In the permission information display method provided in this embodiment, after the permission source information about the access permission of the target account for the reference content is displayed, the user is supported to view the reference content or the object window of the permission source object based on the permission source information, which may enrich a manner of viewing the object window of the permission source object and/or the reference content and a function of the permission source information, to satisfy different viewing requirements of the user.

FIG. 6 is a block diagram of a permission information display apparatus according to an embodiment of the present disclosure. The apparatus may be implemented by software and/or hardware, may be configured in an electronic device, typically in a computer, a mobile phone, or a tablet computer, and may display permission source information about reference content on which interactive content is based when generated by performing a permission information display method. As shown in FIG. 6, the permission information display apparatus provided in this embodiment may include an interactive content display module 601 and a source information display module 602.

The interactive content display module 601 is configured to display first interactive content in a first area of a first interactive page, where the first interactive content is generated based on at least one item of reference content, and reference content information about at least some of the reference content is displayed in association with the first interactive content.

The source information display module 602 is configured to display permission source information about an access permission of a target account for the reference content, in response to a permission source display operation for the reference content.

In the permission information display apparatus provided in this embodiment, the first interactive content is displayed in the first area of the first interactive page by the interactive content display module, where the first interactive content is generated based on at least one item of reference content, and reference content information about at least some of the reference content is displayed in association with the first interactive content; and the permission source information about the access permission of the target account for the reference content is displayed by the source information display module in response to the permission source display operation for the reference content of the first interactive content. In the preceding technical manner in this embodiment, when the interactive content generated based on the reference content is displayed, the user is supported to view the permission source information about the access permission of the user for the reference content, the permission source information about the reference content may be displayed, data security in a process in which the user obtains content is improved, and a risk of data leakage is reduced.

Further, the permission information display apparatus may further include a reference content display module and/or an object window display module. The reference content display module is configured to display the reference content in response to a first trigger operation for the permission source information, after the permission source information about the access permission of the target account for the reference content is displayed. The object window display module is configured to display an object window of a permission source object in response to a second trigger operation for the permission source information, after the permission source information about the access permission of the target account for the reference content is displayed, where the permission source object corresponds to the permission source information.

Optionally, the reference content display module includes at least one of the following: a document content display unit, an interactive content display unit, an entry content display unit, an entry content display unit, or a conference data display unit. The document content display unit is configured to: in response to the reference content being a document, display document content of the document. The interactive content display unit is configured to: in response to the reference content being second interactive content, display the second interactive content in a second area of a second interactive page. The entry content display unit is configured to: in response to the reference content being a question-and-answer entry in a preset question-and-answer database, display entry content of the question-and-answer entry. The entry content display unit is configured to: in response to the reference content being an entry, display entry content of the entry. The conference data display unit is configured to: in response to the reference content being conference content, display conference data of the conference content.

Optionally, the document content display unit may be further configured to display paragraph content of a reference paragraph, corresponding to the first interactive information, in the document; or display paragraph content of a preset paragraph in the document.

Optionally, the conference data includes at least one of conference video data, conference audio data, conference text data, and conference summary data, and the conference text data is obtained by performing speech recognition on the conference audio data.

Optionally, the object window display module may be further configured to display an object information window of the permission source object, and display object information about the permission source object in the object information window; or display an interactive window of the permission source object, where the interactive window is used to perform an interaction associated with the permission source object.

Optionally, the source information display module 602 may include a first information display unit or a second information display unit. The first information display unit is configured to display the permission source information about the access permission of the target account for the reference content in a third area of the first interactive page. The second information display unit is configured to display a permission source information page corresponding to the first interactive content, and display the permission source information about the access permission of the target account for the reference content on the permission source information page.

Optionally, the second information display unit may be further configured to keep displaying the first interactive page, and additionally display the permission source information page corresponding to the first interactive content; or switch a currently displayed page from the first interactive page to the permission source information page corresponding to the first interactive content.

Optionally, the first interactive content includes reply content to third interactive content, and the interactive content display module 601 may be further configured to: in response to receiving the third interactive content in the first area of the first interactive page, generate, in the first area, the reply content corresponding to a target question, where the third interactive content includes the target question.

Optionally, a permission source display control is further displayed in association with the first interactive content, and the permission source display control is configured to trigger execution of the permission source display operation.

The permission information display apparatus provided in the embodiment of the present disclosure may perform the permission information display method provided in any embodiment of the present disclosure, and has corresponding functional modules and beneficial effects for performing the permission information display method. For technical details not described in detail in this embodiment, reference may be made to the permission information display method provided in any embodiment of the present disclosure.

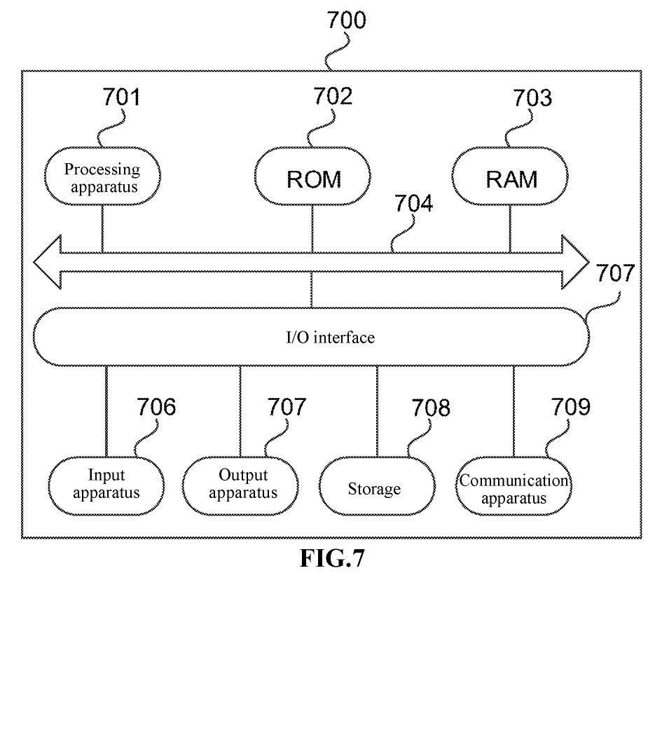

Reference is made to FIG. 7 below, which illustrates a schematic diagram of a structure of an electronic device (such as a terminal device) 700 suitable for implementing an embodiment of the present disclosure. The terminal device in the embodiment of the present disclosure may include, but is not limited to, mobile terminals such as a mobile phone, a notebook computer, a digital broadcast receiver, a PDA (personal digital assistant), a PAD (tablet computer), a PMP (portable multimedia player), and an in-vehicle terminal (such as an in-vehicle navigation terminal), and fixed terminals such as a digital TV and a desktop computer. The electronic device shown in FIG. 7 is merely an example, and shall not impose any limitation on the function and scope of use of the embodiment of the present disclosure.

As shown in FIG. 7, the electronic device 700 may include a processing apparatus (such as a central processing unit and a graphics processor) 701, which may perform various appropriate actions and processing according to a program stored in a read-only memory (ROM) 702 or a program loaded from a storage 708 into a random access memory (RAM) 703. The RAM 703 further stores various programs and data required for operations of the electronic device 700. The processing apparatus 701, the ROM 702, and the RAM 703 are interconnected by means of a bus 704. An input/output (I/O) interface 705 is also connected to the bus 704.

Usually, the following apparatuses may be connected to the I/O interface 705: an input apparatus 706 including, for example, a touch screen, a touchpad, a keyboard, a mouse, a camera, a microphone, an accelerometer, and a gyroscope; an output apparatus 707 including, for example, a liquid crystal display (LCD), a speaker, and a vibrator; the storage 708 including, for example, a magnetic tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or provide all the shown apparatuses. Alternatively, more or fewer apparatuses may be implemented or provided.

In particular, according to the embodiment of the present disclosure, the process described above with reference to the flowchart may be implemented as a computer software program. For example, the embodiment of the present disclosure includes a computer program product, which includes a computer program carried by a non-transitory computer-readable medium, where the computer program includes program code for performing the method shown in the flowchart. In such an embodiment, the computer program may be downloaded and installed from a network via the communication apparatus 709, or installed from the storage 708, or installed from the ROM 702. When the computer program is executed by the processing apparatus 701, the preceding functions defined in the method of the embodiment of the present disclosure are performed.

It should be noted that the computer-readable medium in the present disclosure may be a computer-readable signal medium, a computer-readable storage medium, or any combination thereof. The computer-readable storage medium may be, for example, but is not limited to, an electronic, magnetic, optical, electromagnetic, infrared, or semiconductor system, apparatus, or device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that includes or stores a program, and the program may be used by or used in combination with an instruction execution system, apparatus, or device. In the present disclosure, the computer-readable signal medium may include a data signal propagated on a baseband or as a part of a carrier, and computer-readable program code is carried in the data signal. The data signal propagated in this manner may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted in any suitable medium, including, but not limited to, a wire, an optical cable, a radio frequency (RF), or any suitable combination thereof.

In some implementations, a client and a server may communicate using any currently known or future developed network protocol, such as the hypertext transfer protocol (HTTP), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The computer-readable medium may be included in the electronic device, or may exist alone without being assembled into the electronic device.

The computer-readable medium carries one or more programs which, when executed by the electronic device, cause the electronic device to: display first interactive content in a first area of a first interactive page, where the first interactive content is generated based on at least one item of reference content, and reference content information about at least some of the reference content is displayed in association with the first interactive content; and display permission source information about an access permission of a target account for the reference content, in response to a permission source display operation for the reference content.

The computer program code for performing the operations of the present disclosure may be written in one or more programming languages or a combination thereof, where the programming languages include, but are not limited to, an object-oriented programming language such as Java, Smalltalk, and C++, and further include conventional procedural programming languages such as "C" language or similar programming languages. The program code may be completely executed on a computer of a user, partially executed on a computer of a user, executed as an independent software package, partially executed on a computer of a user and partially executed on a remote computer, or completely executed on a remote computer or server. In the case of involving the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which includes one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments of the present disclosure may be implemented by software or hardware. The name of a module does not constitute a limitation on the unit itself under certain circumstances.

The functions described above herein may be performed at least partially by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logical device (CPLD), and the like.

In the context of the present disclosure, the machine-readable medium may be a tangible medium and may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, Example 1 provides a permission information display method, including:

displaying first interactive content in a first area of a first interactive page, where the first interactive content is generated based on at least one item of reference content, and reference content information about at least some of the reference content is displayed in association with the first interactive content; and

displaying permission source information about an access permission of a target account for the reference content, in response to a permission source display operation for the reference content.

According to one or more embodiments of the present disclosure, Example 2 is the method according to Example 1, where after displaying the permission source information about the access permission of the target account for the reference content, the method further includes:

displaying the reference content in response to a first trigger operation for the permission source information; and/or

displaying an object window of a permission source object in response to a second trigger operation for the permission source information, where the permission source object corresponds to the permission source information.

According to one or more embodiments of the present disclosure, Example 3 is the method according to Example 2, where displaying the reference content includes at least one of the following:

in response to the reference content being a document, displaying document content of the document;

in response to the reference content being second interactive content, displaying the second interactive content in a second area of a second interactive page;

in response to the reference content being a question-and-answer entry in a preset question-and-answer database, displaying entry content of the question-and-answer entry;

in response to the reference content being an entry, displaying entry content of the entry; and

in response to the reference content being conference content, displaying conference data of the conference content.

According to one or more embodiments of the present disclosure, Example 4 is the method according to Example 3, where displaying the document content of the document includes:

displaying paragraph content of a reference paragraph, corresponding to the first interactive information, in the document; or

displaying paragraph content of a preset paragraph in the document.

According to one or more embodiments of the present disclosure, Example 5 is the method according to Example 3, where the conference data includes at least one of conference video data, conference audio data, conference text data, and conference summary data, and the conference text data is obtained by performing speech recognition on the conference audio data.

According to one or more embodiments of the present disclosure, Example 6 is the method according to Example 2, where displaying the object window of the permission source object includes:

displaying an object information window of the permission source object, and displaying object information about the permission source object in the object information window; or

displaying an interactive window of the permission source object, where the interactive window is used to perform an interaction associated with the permission source object.

According to one or more embodiments of the present disclosure, Example 7 is the method according to any one of Examples 1 to 6, where displaying the permission source information about the access permission of the target account for the reference content includes:

displaying the permission source information about the access permission of the target account for the reference content in a third area of the first interactive page; or

displaying a permission source information page corresponding to the first interactive content, and displaying the permission source information about the access permission of the target account for the reference content on the permission source information page.

According to one or more embodiments of the present disclosure, Example 8 is the method according to Example 7, where displaying the permission source information page corresponding to the first interactive content includes:

displaying continuously the first interactive page, and displaying additionally the permission source information page corresponding to the first interactive content; or

switching a currently displayed page from the first interactive page to the permission source information page corresponding to the first interactive content.

According to one or more embodiments of the present disclosure, Example 9 is the method according to any one of Examples 1 to 6, where the first interactive content includes reply content to third interactive content, and displaying the first interactive content in the first area of the first interactive page includes:

in response to receiving the third interactive content in the first area of the first interactive page, generating, in the first area, reply content corresponding to a target question, where the third interactive content includes the target question.

According to one or more embodiments of the present disclosure, Example 10 is the method according to any one of Examples 1 to 6, where a permission source display control is further displayed in association with the first interactive content, and the permission source display control is configured to trigger execution of the permission source display operation.

According to one or more embodiments of the present disclosure, Example 11 provides a permission information display apparatus, including:

an interactive content display module, configured to display first interactive content in a first area of a first interactive page, where the first interactive content is generated based on at least one item of reference content, and reference content information about at least some of the reference content is displayed in association with the first interactive content; and

a source information display module, configured to display permission source information about an access permission of a target account for the reference content, in response to a permission source display operation for the reference content.

According to one or more embodiments of the present disclosure, Example 12 provides an electronic device, including:

one or more processors; and

a memory, configured to store one or more programs,

where the one or more programs, when executed by the one or more processors, cause the one or more processors to implement the permission information display method according to any one of Examples 1 to 10.

According to one or more embodiments of the present disclosure, Example 13 provides a computer-readable storage medium having a computer program stored thereon, where the program, when executed by a processor, cause the processor to implement the permission information display method according to any one of Examples 1 to 10.

According to one or more embodiments of the present disclosure, Example 14 provides a computer program product which, when executed by a computer, causes the computer to implement the permission information display method according to any one of Examples 1 to 10.

The preceding description is only preferred embodiments of the present disclosure and an explanation of the applied technical principles. Those skilled in the art should understand that the scope of disclosure involved in the present disclosure is not limited to the technical solution formed by the specific combination of the preceding technical features, and should also cover other technical solutions formed by any combination of the preceding technical features or their equivalent features without departing from the preceding concept of disclosure. For example, the preceding features and the technical features disclosed in the present disclosure (but not limited to) and having similar functions are replaced each other to form a technical solution.

In addition, although the operations are depicted in a specific order, this should not be understood as requiring the operations to be performed in the specific order shown or in a sequential order. Under certain circumstances, multitasking and parallel processing may be advantageous. Similarly, although the preceding discussion contains a number of specific implementation details, these should not be construed as limiting the scope of the present disclosure. Certain features described in the context of separate embodiments may also be implemented in a single embodiment in combination. On the contrary, various features described in the context of a single embodiment may also be implemented in multiple embodiments individually or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are only exemplary forms of implementing the claims.

We claim:

1. A permission information display method, comprising:
displaying first interactive content in a first area of a first interactive page, the first interactive content being generated based on at least one item of reference content, and reference content information about at least some of the reference content being displayed in association with the first interactive content; and
displaying permission source information about an access permission of a target account for the reference content, in response to a permission source display operation for the reference content.

2. The method of claim 1, further comprising: after displaying the permission source information about the access permission of the target account for the reference content,
displaying the reference content in response to a first trigger operation for the permission source information; and/or
displaying an object window of a permission source object in response to a second trigger operation for the permission source information, the permission source object corresponding to the permission source information.

3. The method of claim 2, wherein displaying the reference content comprises at least one of:
displaying, in response to the reference content being a document, document content of the document;
displaying, in response to the reference content being second interactive content, the second interactive content in a second area of a second interactive page;
displaying, in response to the reference content being a question-and-answer entry in a preset question-and-answer database, entry content of the question-and-answer entry;
displaying, in response to the reference content being an entry, entry content of the entry; and
displaying, in response to the reference content being conference content, conference data of the conference content.

4. The method of claim 3, wherein displaying the document content of the document comprises:
displaying paragraph content of a reference paragraph in the document corresponding to the first interactive information; or
displaying paragraph content of a preset paragraph in the document.

5. The method of claim 3, wherein the conference data comprises at least one of conference video data, conference audio data, conference text data, or conference summary data, and the conference text data is obtained by performing speech recognition on the conference audio data.

6. The method of claim 2, wherein displaying the object window of the permission source object comprises:
displaying an object information window of the permission source object, and displaying object information about the permission source object in the object information window; or
displaying an interactive window of the permission source object, the interactive window being used to perform an interaction associated with the permission source object.

7. The method of claim 1, wherein displaying the permission source information about the access permission of the target account for the reference content comprises:
displaying the permission source information about the access permission of the target account for the reference content in a third area of the first interactive page; or
displaying a permission source information page corresponding to the first interactive content, and displaying the permission source information about the access permission of the target account for the reference content on the permission source information page.

8. The method of claim 7, wherein displaying the permission source information page corresponding to the first interactive content comprises:
displaying continuously the first interactive page, and displaying additionally the permission source information page corresponding to the first interactive content; or
switching a currently displayed page from the first interactive page to the permission source information page corresponding to the first interactive content.

9. The method of claim 1, wherein the first interactive content comprises reply content to third interactive content, and wherein displaying the first interactive content in the first area of the first interactive page comprises:
generating, in the first area, in response to receiving the third interactive content in the first area of the first interactive page, reply content corresponding to a target question, the third interactive content comprising the target question.

10. The method of claim 1, wherein a permission source display control is further displayed in association with the first interactive content, and the permission source display control is configured to trigger execution of the permission source display operation.

11. An electronic device, comprising:
at least one processor; and
a memory communicatively connected to the at least one processor;
wherein the memory stores a computer program executable by the at least one processor, and the computer program, when executed by the at least one processor, causes the at least one processor to:
display first interactive content in a first area of a first interactive page, the first interactive content being generated based on at least one item of reference content, and reference content information about at least some of the reference content being displayed in association with the first interactive content; and
display permission source information about an access permission of a target account for the reference content, in response to a permission source display operation for the reference content.

12. The electronic device of claim 11, wherein the computer program, when executed by the at least one processor, further causes the at least one processor to: after displaying the permission source information about the access permission of the target account for the reference content,
display the reference content in response to a first trigger operation for the permission source information; and/or
display an object window of a permission source object in response to a second trigger operation for the permission source information, the permission source object corresponding to the permission source information.

13. The electronic device of claim 12, wherein the computer program causing the at least one processor to display the reference content further causes the at least one processor to perform at least one of:
displaying, in response to the reference content being a document, document content of the document;
displaying, in response to the reference content being second interactive content, the second interactive content in a second area of a second interactive page;
displaying, in response to the reference content being a question-and-answer entry in a preset question-and-answer database, entry content of the question-and-answer entry;
displaying, in response to the reference content being an entry, entry content of the entry; and
displaying, in response to the reference content being conference content, conference data of the conference content.

14. The electronic device of claim 13, wherein the computer program causing the at least one processor to display the document content of the document further causes the at least one processor to:
display paragraph content of a reference paragraph in the document corresponding to the first interactive information; or
display paragraph content of a preset paragraph in the document.

15. The electronic device of claim 13, wherein the conference data comprises at least one of conference video data, conference audio data, conference text data, or conference summary data, and the conference text data is obtained by performing speech recognition on the conference audio data.

16. The electronic device of claim 12, wherein the computer program causing the at least one processor to display the object window of the permission source object further causes the at least one processor to:
display an object information window of the permission source object, and display object information about the permission source object in the object information window; or
display an interactive window of the permission source object, the interactive window being used to perform an interaction associated with the permission source object.

17. The electronic device of claim 11, wherein the computer program causing the at least one processor to display the permission source information about the access permission of the target account for the reference content further causes the at least one processor to:
display the permission source information about the access permission of the target account for the reference content in a third area of the first interactive page; or
display a permission source information page corresponding to the first interactive content, and display the permission source information about the access permission of the target account for the reference content on the permission source information page.

18. The electronic device of claim 17, wherein the computer program causing the at least one processor to display the permission source information page corresponding to the first interactive content further causes the at least one processor to:
display continuously the first interactive page, and display additionally the permission source information page corresponding to the first interactive content; or
switch a currently displayed page from the first interactive page to the permission source information page corresponding to the first interactive content.

19. The electronic device of claim 11, wherein the first interactive content comprises reply content to third interactive content, and wherein the computer program causing the at least one processor to display the first interactive content in the first area of the first interactive page further causes the at least one processor to:
generate, in the first area, in response to receiving the third interactive content in the first area of the first interactive page, reply content corresponding to a target question, the third interactive content comprising the target question.

20. A non-transitory computer-readable storage medium, wherein the computer-readable storage medium stores computer instructions, and the computer instructions, when executed by a processor, cause the processor to:
display first interactive content in a first area of a first interactive page, the first interactive content being generated based on at least one item of reference content, and reference content information about at least some of the reference content being displayed in association with the first interactive content; and
display permission source information about an access permission of a target account for the reference content, in response to a permission source display operation for the reference content.
